(19) United States
(12) Patent Application Publication
(10) Pub. No.: US 2017/0198584 A1
(43) Pub. Date: Jul. 13, 2017

(54) SYSTEMS AND METHODS FOR REPAIRING A COMPONENT OF A ROTARY MACHINE

(71) Applicant: General Electric Company, Schenectady, NY (US)

(72) Inventors: Cem Murat Eminoglu, Simpsonville, SC (US); Cody Jermaine Ford, Simpsonville, SC (US); Brad Wilson VanTassel, Easley, SC (US); Yan Cui, Greer, SC (US)

(21) Appl. No.: 14/993,842

(22) Filed: Jan. 12, 2016

(51) Int. Cl. F01D 5/00; F01D 9/02; F01D 5/12

(52) U.S. Cl. CPC F01D 5/005; F01D 5/12; F01D 9/02; F05D 2230/10; F05D 2230/80; F05D 2230/237

(57) ABSTRACT

A component includes a substrate configured to receive tensile stress in a first direction. The substrate includes a recess defined therein on a surface. The recess includes a first portion having a first width defined in a second direction. The recess also includes a second portion having a second width defined substantially parallel to the second direction, and a third portion between the first and second portions along the first direction. The third portion having a third width defined substantially parallel to the second direction such that each of the first width and the second width is different than the third width. The component further includes an insert coupled to the substrate. A perimeter of the insert is sized substantially identically to a perimeter of the recess such that the insert is received within the recess in a clearance fit.

### BACKGROUND

The present disclosure relates generally to rotary machines and, more specifically, to systems and methods for repairing a component of a rotary machine.

At least some known rotary machines, such as gas turbines, include components, such as, but not limited to, turbine nozzles, rotor blade airfoils, and/or shrouds, that may be exposed to mechanical stresses during operation. At least some of such components may incur damage, for example, a crack may form within the substrate when subjected to tension loading thus reducing the service life of the components. Repair of some such components requires removing the damaged area from the substrate via machining. The removed area is replaced by an insert or coupon that is welded into the cavity created by the removal of the damaged area. In at least some components, the weld between the insert and the substrate may carry the entire tension loading on the component while the rotary machine is in operation, thereby relying on a high quality of the weld for the insert to function. However, at least some components are formed from a substrate material, such as a high gamma prime superalloy, for which it is difficult to achieve a high-quality weld. Additionally or alternatively, at least some known repair methods require brazing the replacement insert onto the component substrate. However, at least some brazes do not perform well under tension loading.

### BRIEF DESCRIPTION

In one aspect, a component is provided. The component includes a substrate configured to receive tensile stress in a first direction. The substrate includes a recess defined therein on a surface of the substrate. The recess includes a first portion having a first width defined in a second direction extending substantially transverse to the first direction along the surface. The recess also includes a second portion having a second width defined substantially parallel to the second direction, and a third portion between the first and second portions along the first direction. The third portion having a third width defined substantially parallel to the second direction such that each of the first width and the second width is different than the third width. The component further includes an insert coupled to the substrate. A perimeter of the insert is sized substantially identically to a perimeter of the recess such that the insert is received within the recess in a clearance fit.

In another aspect, a rotary machine is provided. The rotary machine includes a component configured to receive tensile stress when the rotary machine is in operation. The component includes a substrate and a recess defined therein on a surface of the substrate. The recess includes a first portion having a first width defined substantially transverse tensile stress along the substrate and a second portion having a second width defined substantially transverse to tensile stress along the substrate. The recess further includes a third portion between the first and second portions along the tensile stress direction. The third portion having a third width defined substantially transverse to tensile stress along the substrate such that each of the first width and the second width is different than the third width. The component further includes an insert coupled to the substrate. A perimeter of the insert is sized substantially identical to a perimeter of the recess such that the insert is received within the recess in a clearance fit.

In another aspect, a method for repairing a component is provided. The method includes removing a damaged area from a substrate of the component such that a recess is created in a surface of the substrate. The substrate is configured to receive tensile stress in a first direction. The recess includes a first portion having a first width defined in a second direction extending substantially transverse to the first direction along the surface. The recess also includes a second portion having a second width defined substantially parallel to the second direction and a third portion between the first and second portions and having a third width defined substantially parallel to the second direction such that each of the first and second widths are different than the third width. The method further includes coupling an insert to the substrate. A perimeter of the insert is sized substantially identically to a perimeter of the recess such that the insert is received within the recess in a clearance fit.

### BRIEF DESCRIPTION OF THE DRAWINGS

FIG. 1 is a schematic view of an exemplary rotary machine;

FIG. 2 is a side sectional view of a portion of an exemplary turbine assembly that may be used with the rotary machine shown in FIG. 1;

FIG. 3 is a perspective exploded view of an exemplary component that may be used with the turbine assembly shown in FIG. 2, wherein the component includes an exemplary repair insert coupled to a substrate of the component;

FIG. 4 is a plan view of an exemplary insert coupled to a substrate of a component of the rotary machine shown in FIG. 1;

FIG. 5 is a plan view of a another exemplary insert coupled to a substrate of a component of the rotary machine shown in FIG. 1;

FIG. 6 is a plan view of a further exemplary insert coupled to a substrate of a component of the rotary machine shown in FIG. 1;

FIG. 7 is a plan view of yet another exemplary insert coupled to a substrate of a component of the rotary machine shown in FIG. 1; and

FIG. 8 is a flow diagram of an exemplary method of repairing a component, such as a component of the rotary machine shown in FIG. 1.

### DETAILED DESCRIPTION OF THE INVENTION

The exemplary repair inserts and methods described herein overcome at least some of the disadvantages associated with known repair inserts and methods for repairing a rotary machine component. The exemplary components described herein include a recess defined on a surface of a substrate that receives tensile stresses and an insert coupled to the substrate such that the insert is received within the recess in a clearance fit. For example, in one embodiment, the recess is formed by removing a damaged portion of the substrate. The recess is shaped to transfer tensile stresses from the substrate to the insert regardless of the quality of a weld or other attachment structure between the insert and the substrate. In some embodiments, the insert receives the tensile stresses from the substrate via shear along the perimeter of the insert. In each embodiment, the insert facilitates increasing the strength of the repair.

Unless otherwise indicated, approximating language, such as “generally,” “substantially,” and “about,” as used herein indicates that the term so modified may apply to only an approximate degree, as would be recognized by one of ordinary skill in the art, rather than to an absolute or perfect degree. Approximating language may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be identified. Such ranges may be combined and/or interchanged, and include all the sub-ranges contained therein unless context or language indicates otherwise.

Additionally, unless otherwise indicated, the terms “first,” “second,” etc. are used herein merely as labels, and are not intended to impose ordinal, positional, or hierarchical requirements on the items to which these terms refer. Moreover, reference to, for example, a “second” item does not require or preclude the existence of, for example, a “first” or lower-numbered item or a “third” or higher-numbered item.

As used herein, the terms “axial” and “axially” refer to directions and orientations extending substantially parallel to a longitudinal axis of a rotary machine. Moreover, the terms “radial” and “radially” refer to directions and orientations extending substantially perpendicularly to the longitudinal axis of the rotary machine. In addition, as used herein, the terms “circumferential” and “circumferentially” refer to directions and orientations extending arcuately about the longitudinal axis of the rotary machine. The term “fluid” as used herein includes any medium or material that flows, including, but not limited to, air. As used herein, the term “component” refers to any structure within a rotary machine that may be subject to tensile stresses. In addition, although embodiments of the disclosure are described with reference to components of rotary machines, it should be understood that the scope of the disclosure encompasses any suitable component of any suitable structure for which the embodiments are enabled to function as described herein.

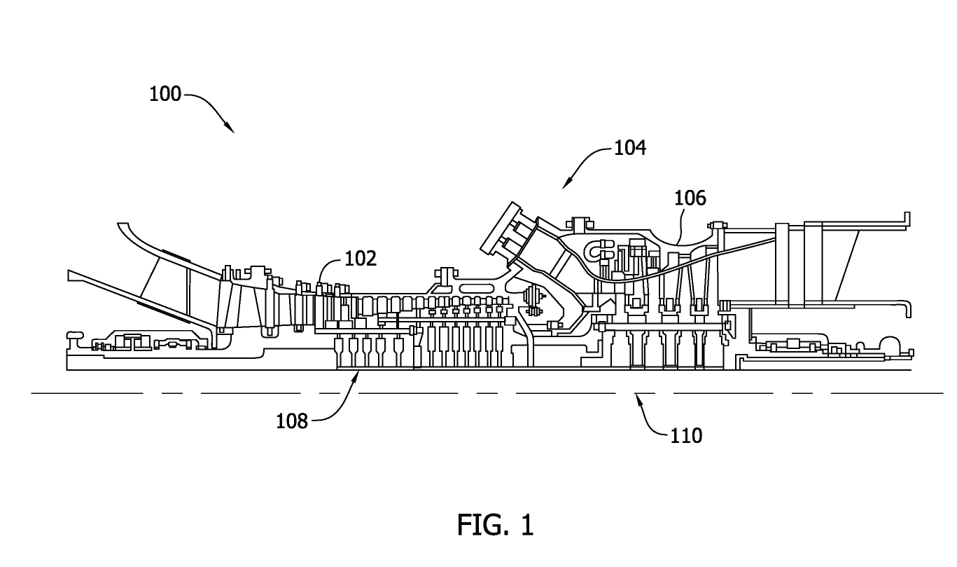

FIG. 1 is a schematic view of a rotary machine 100, e.g., a turbomachine. In the exemplary embodiment, rotary machine 100 is a gas turbine engine. Rotary machine 100 includes a compressor assembly 102. A combustor assembly 104 is coupled downstream from, and in flow communication with, compressor assembly 102, and a turbine assembly 106 is coupled downstream from, and in flow communication with, combustor assembly 104. Turbine assembly 106 is coupled to compressor assembly 102 via a rotor assembly 108. In operation, compressor assembly 102 compresses inlet air to higher pressures and temperatures prior to discharging compressed air towards combustor assembly 104. The compressed air is mixed with fuel and burned within combustor assembly 104 to generate combustion gases that are channeled downstream toward turbine assembly 106. As the combustion gases impinge turbine assembly 106, thermal energy is converted to mechanical rotational energy that is used to drive rotor assembly 108. Rotor assembly 108 rotates about rotary machine axis 110.

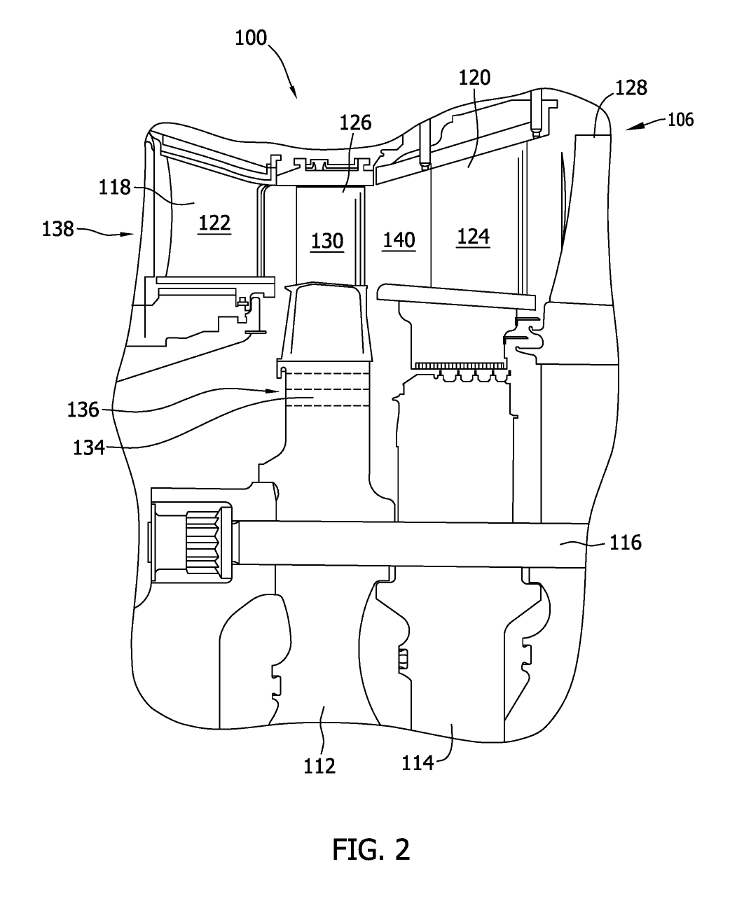

FIG. 2 is a side sectional view of a portion of an exemplary turbine assembly 106 of rotary machine 100. In the exemplary embodiment, turbine assembly 106 includes axially-spaced apart rotor disks 112 and spacer 114 that are coupled to each other, for example, by a plurality of circumferentially-spaced, axially-extending bolts 116. Although bolts 116 are shown for use in coupling disks 112 to spacers 114, any other suitable coupling structures may be used that enables rotary machine 100 to operate as described herein. Rotary machine 100 includes a plurality of first-stage nozzles 118 and a plurality of second-stage nozzles 120. Each plurality of nozzles 118 and 120 includes a plurality of circumferentially-spaced stator vanes, such as first and second stage stator vanes 122 and 124, respectively. A plurality of first-stage rotor blades 126 are coupled via disk 112 to rotor assembly 108 (shown in FIG. 1) for rotation between nozzles 118 and 120. Similarly, a plurality of second-stage rotor blades 128 are coupled to rotor assembly 108 for rotation between second-stage nozzles 120 and a third stage of nozzles (not shown). Although two stages of rotor blades and two stages of nozzles are illustrated, it should be understood that turbine assembly 106 includes any suitable number of stages that enables rotary machine 100 to function as described herein.

In the exemplary embodiment, each rotor blade 126 includes an airfoil 130. Additionally, each rotor blade 126 includes a dovetail 134 coupled to rotor disk 112. Dovetail 134 is inserted axially within a suitably-shaped slot 136 defined in rotor disk 112. During operation, a flow 138 of hot combustion gases is channeled through a rotor/stator cavity 140 exposing airfoil 130 to flow 138 causing rotation of disk 112 and subjecting rotor blades 126 to centrifugal forces.

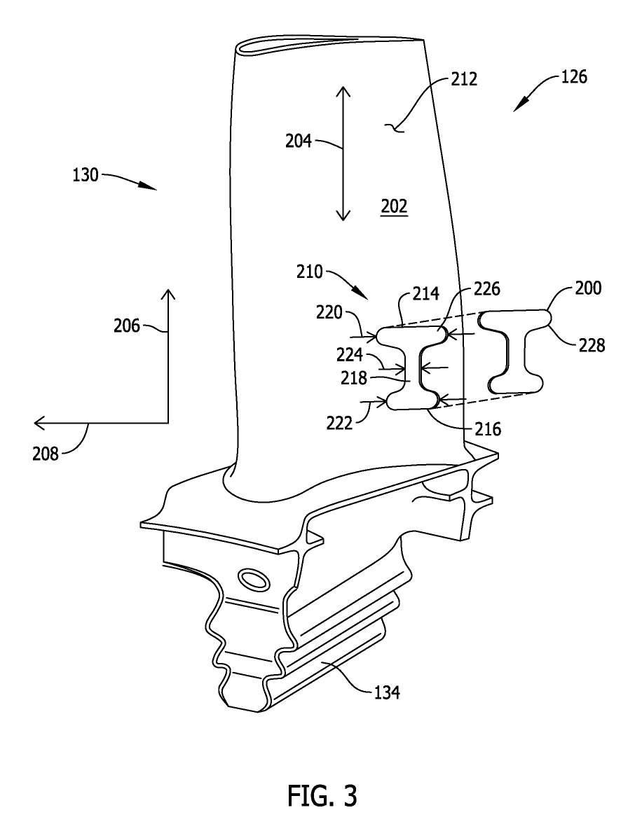

FIG. 3 is a perspective exploded view of an exemplary rotor blade 126 for use with turbine assembly 106 (shown in FIG. 2). In the illustrated embodiment, rotor blade 126 includes an exemplary repair insert 200 coupled to rotor blade 126. In the exemplary embodiment, airfoil 130 of rotor blade 126 includes a substrate 202 covered with a coating; however the coating is not shown for purposes of illustration. In alternative embodiments, airfoil 130 is not coated. Although embodiments of insert 200 are illustrated herein as being coupled to airfoil 130 of rotor blade 126, this disclosure contemplates embodiments of insert 200 as being coupled to any suitable portion of rotor blade 126, nozzle 118, or any other suitable component of rotary machine 100.

In certain embodiments, substrate 202 may be subjected to tensile stress 204 during operation of rotary machine 100 (shown in FIG. 1). In the exemplary embodiment, substrate 202 is formed as a one-piece casting of a first material, such as a suitable high gamma prime superalloy, such as, for example, a nickel-based superalloy, that has acceptable strength at the elevated temperatures and pressures during operation of rotary machine 100. In alternative embodiments, the material from which substrate 202 is formed is any other suitable material that enables rotor blade 126 to function as described herein.

A first direction 206 is defined as being substantially parallel to the direction of tensile stress 204 in the component to which insert 200 is coupled. For example, during operation of rotary machine 100, rotor blade 126 is exposed to centrifugal forces during rotation about axis 110 (shown in FIG. 1). Centrifugal forces subject rotor blade 126 to tensile stress 204 in first direction 206 defined as being substantially parallel to a radial direction of rotor blade 126. Tensile stress 204 inducted along first direction 206 may cause damage to substrate 202. For example, damage, such as a crack (not shown), may occur on substrate 202 in an area that is substantially parallel to a second direction 208. Second direction 208 is defined as being substantially transverse to first direction 206.

To repair damage to substrate 202, the damaged area is removed from substrate 202, to create a recess 210 within substrate 202. In the exemplary embodiment, recess 210 extends within substrate 202 from a surface 212 of substrate 202 to a depth defined within substrate 202 that is beyond a depth of the damage, such that the entire damaged section is removed from substrate 202. In alternative embodiments, recess 210 is created to any suitable size that enables insert 200 to function as described herein. In the exemplary embodiment, recess 210 is formed by machining substrate 202. In alternative embodiments, recess 210 is formed via any suitable method that enables repair of substrate 202 as described herein.

In the exemplary embodiment, recess 210 includes a first portion 214, a second portion 216, and a third portion 218 defined between first portion 214 and second portion 216 with respect to first direction 206. First portion 214 has a first width 220 defined substantially parallel to second direction 208, second portion 216 has a second width 222 defined substantially parallel to second direction 208, and third portion 218 has a third width 224 defined substantially parallel to second direction 208. In the exemplary embodiment, first portion 214 and second portion 216 are each generally elliptical, and third portion 218 extends from first portion 214 to second portion 216 in a substantially rectangular shape. In alternative embodiments, first portion 214, second portion 216, and/or third portion 218 may have any suitable shape that enables insert 200 to function as described herein.

In the exemplary embodiment, first portion 214 is formed on a first side of the damaged area with reference to first direction 206, second portion 216 is formed on an opposite second side of the damaged area with reference to first direction 206, and third portion 218 is formed therebetween, such that the damaged area is substantially removed from substrate 202. Specifically, recess 210 is sized such that not only the damaged area of substrate 202 is removed, but also non-damaged portions of substrate 202, such as first portion 214 and second portion 216, to facilitate increasing strength of the repair.

In the exemplary embodiment, first width 220 of first portion 214 and second width 222 of second portion 216 are each more than third width 224 of third portion 218. In certain embodiments, first width 220 of first portion 214 and second width 222 of second portion 216 are each more than twice third width 224 of third portion 218. First portion 214, second portion 216, and third portion 218 cooperate to define a perimeter of recess 226 in substrate 202. In the exemplary embodiment, insert 200 has a perimeter 228 that is sized approximately identically to that of recess perimeter 226, such that insert 200 is received within recess 210 in a clearance fit. The relationship of first width 220, second width 222, and third width 224 ensures that tensile stress 204 induced parallel to first direction 206 are effectively transferred to insert 200 from portions of substrate 202 surrounding recess 210, as will be described herein, and regardless of the strength of a bond formed between insert 200 and substrate 202.

In the exemplary embodiment, insert 200 is coupled to substrate 202 via a brazed metallurgical bond between adjacent faces of insert 200 and substrate 202 and/or between recess perimeter 226 and insert perimeter 228. The brazing process includes placing a brazing tape and/or brazing paste with a relatively low melting temperature between and/or on insert 200 and substrate 202, and then heating the braze material to a high temperature. The high temperature melts the braze material and fuses insert 200 and substrate 202 without melting either insert 200 or substrate 202. The brazed metallurgical bond is stronger under shear than in tension and seals insert 200 within substrate 202 preventing working fluid within rotary machine 100 (shown in FIG. 1) to pass between. In alternative embodiments, insert 200 is welded to substrate 202 at recess perimeter 226 and insert perimeter 228 thereby also sealing insert 200 within substrate 202. In other alternative embodiments, insert 200 is coupled to substrate 202 via any other coupling method that enables insert 200 to function as described herein. As noted above, the relationship of first width 220, second width 222, and third width 224 ensures that tensile stress 204 induced parallel to first direction 206 are effectively transferred to insert 200 from portions of substrate 202 surrounding recess 210, as will be described herein, regardless of a strength of a bond formed between insert 200 and substrate 202 along recess perimeter 226.

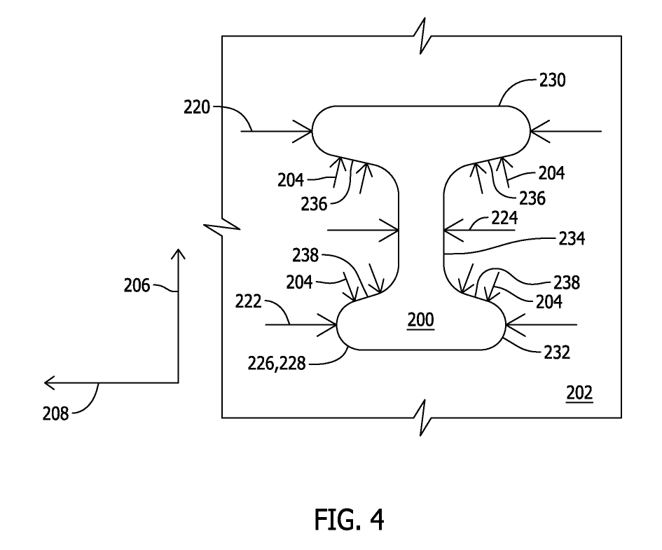

FIG. 4 is a plan view of an exemplary insert 200 coupled to substrate 202 of a component of rotary machine 100 (shown in FIG. 1). In the exemplary embodiment, insert 200 has perimeter 228 that is sized substantially identically to recess perimeter 226. Additionally, insert 200 includes a first portion 230 that substantially corresponds in shape and size to first portion 214 of recess 210, a second portion 232 that substantially corresponds in shape and size to second portion 216 of recess 210, and a third portion 234 that substantially corresponds in shape and size to third portion 218 of recess 210. In alternative embodiments, insert 200 has any suitable shape that enables insert 200 to function as described herein.

In operation, tensile stress 204 induced within substrate 202 substantially parallel to first direction 206 are transferred to insert 200 at first portion 230 and second portion 232. More specifically, tensile stress 204 within substrate 202 are received by first portion 230 at an interface 236 defined between recess perimeter 226 and insert perimeter 228, and received within second portion 232 at an interface 238 defined between recess perimeter 226 and insert perimeter 228. Thus, tensile stress 204 are transferred directly from substrate 202 to insert 200 without relying on a tensile strength of the metallurgical bond and/or weld between insert 200 and substrate 202, such that a load carrying capacity of insert 200 is increased. Moreover, in certain embodiments, because first width 220 of first portion 214 and second width 222 of second portion 216 are each more than twice as wide as third width 224 of third portion 218, interface 236 and interface 238 each have a width at least equal to third width 224. The metallurgical bond and/or weld are sufficiently strong to inhibit insert 200 from decoupling from substrate 202 in a direction substantially normal to surface 212 during operation of rotary machine 100.

In some embodiments, insert 200 is formed from a second material that has at least one of a tensile strength, creep resistance, and fatigue resistance, such as low-cycle fatigue, that is greater than the first material from which substrate 202 is formed. For example, insert 200 is formed from a suitable high gamma prime superalloy, such as a nickel-based superalloy, that has a tensile strength greater than a tensile strength of a material from which substrate 202 is formed. The greater tensile strength of the second material facilitates insert 200 carrying a tensile load applied across first width 220 and second width 222 through the narrower third width 224. In alternative embodiments, the second material from which insert 200 is formed is any other suitable material that enables insert 200 to function as described herein. For example, insert 200 is formed from a substantially identical material to the first material of substrate 202.

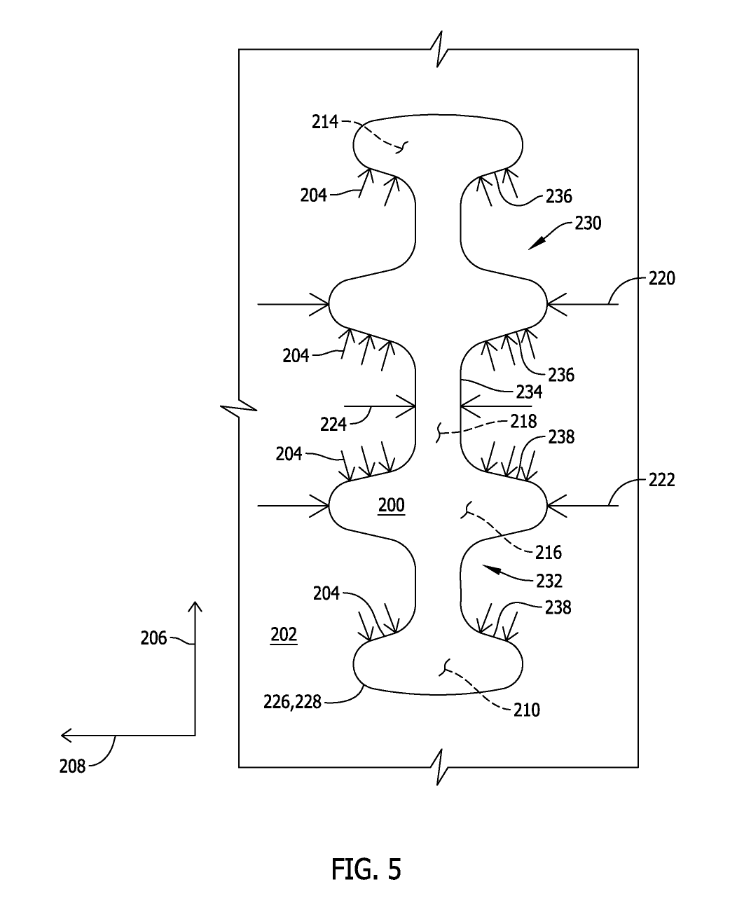

FIG. 5 is a plan view of another exemplary insert 200 coupled to substrate 202 of a component of rotary machine 100 (shown in FIG. 1). In the exemplary embodiment, insert 200 again defines a perimeter 228 that is sized substantially identically to recess perimeter 226 of recess 210 formed in substrate 202. Additionally, first portion 214 is again formed on a first side of the damaged area with reference to first direction 206, second portion 216 is again formed on an opposite second side of the damaged area with reference to first direction 206, and third portion 218 is again formed therebetween, such that the damaged area is substantially removed from substrate 202.

Similarly, first width 220 of first portion 214 and second width 222 of second portion 216 are each more than third width 224 of third portion 218. However, in this exemplary embodiment, recess 210 has a substantially dovetail shape at first and second portions 214 and 216, and insert 200 has a corresponding substantially dovetail shape at first and second portions 230 and 232. In alternative embodiments, each of recess 210 and insert 200 has any suitable shape that enables insert 200 to function as described herein. In operation, tensile stress 204 induced within substrate 202 are received within first portion 230 at a plurality of interfaces 236 and received within second portion 232 at a plurality of interfaces 238. Thus, tensile stress 204 are transferred directly from substrate 202 to insert 200 without relying on a tensile strength of the metallurgical bond and/or weld between insert 200 and substrate 202. Insert 200 is coupled to substrate 202 as described previously. Also as described previously, in certain embodiments, insert 200 is formed from a second material that has a tensile strength greater than a tensile strength of the first material from which substrate 202 is formed, and in some embodiments, the ratio of tensile strength of the second material to the tensile strength of the first material is greater than or equal to the ratio of first width 220 and/or second width 222 to third width 224.

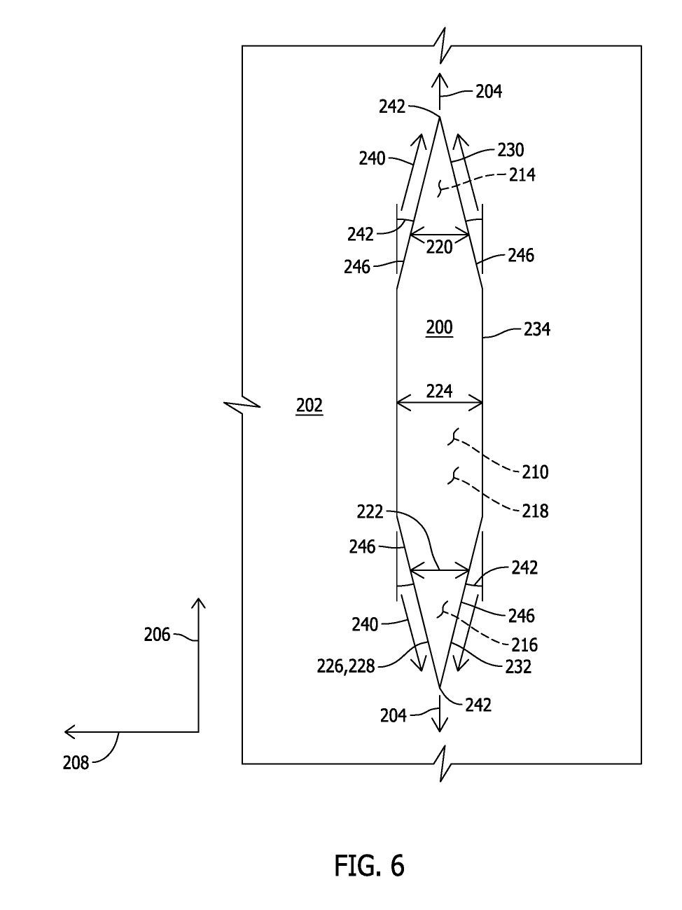

FIG. 6 is a plan view of a further exemplary insert 200 coupled to substrate 202 of a component of rotary machine 100 (shown in FIG. 1). In the exemplary embodiment, insert 200 again defines a perimeter 228 that is sized substantially identically to recess perimeter 226 of recess 210 formed in substrate 202. Additionally, first portion 214 is again formed on a first side of the damaged area with reference to first direction 206, second portion 216 is again formed on an opposite second side of the damaged area with reference to first direction 206, and third portion 218 is again formed therebetween, such that the damaged area is substantially removed from substrate 202. Moreover, first width 220 of first portion 214 and second width 222 of second portion 216 are each less than third width 224 of third portion 218.

In certain embodiments, perimeters 226 and 228 define a plurality of perimeter portions 246 each aligned at an acute angle 242 relative to first direction 206. For example, in the exemplary embodiment, first portion 230 and second portion 232 of insert 200 each define two portions 246 of perimeter 228 having respective acute angles 242 with respect to first direction 206. Insert 200 is coupled to substrate 202 by a brazed metallurgical bond at least between recess perimeter 226 and insert perimeter 228. Respective acute angles 242 are selected such that the brazed metallurgical bond is substantially in shear when substrate 202 is subjected to tensile stress 204. For example, each acute angle 242 is less than or equal to about 30 degrees. For another example, each acute angle 242 is less than or equal to about 20 degrees. In alternative embodiments, each acute angle 242 has any suitable value and/or insert 200 has any other suitable shape that enables insert 200 to function as described herein.

In operation, tensile stress 204 is transferred to insert 200 through shear stress 240 along the brazed metallurgical bond. Because such brazed metallurgical bonds are stronger under shear than under tension, the plurality of portions 246 of recess perimeter 226, and thus of insert perimeter 228, each aligned at an acute angle 242 relative to first direction 206 enable a substantial proportion of tensile stress 204 to be transferred through insert 200 with a decreased risk of failure of the brazed metallurgical bond. Thus, a load carrying capacity of insert 200 is increased.

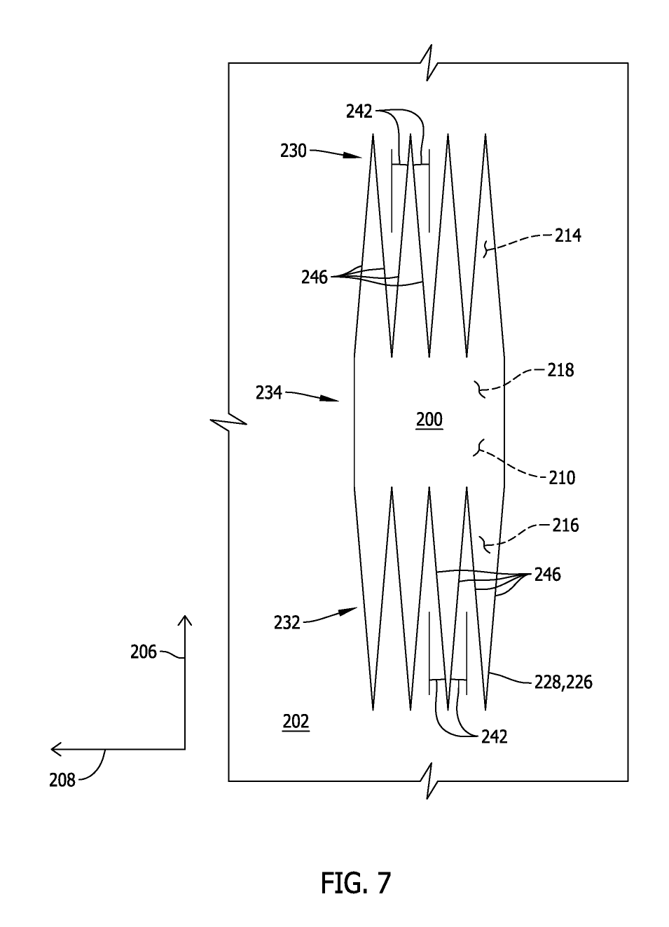

FIG. 7 is a plan view of yet another exemplary insert 200 coupled to substrate 202 of a component of rotary machine 100 (shown in FIG. 1). Similar to the embodiment shown in FIG. 6, perimeters 226 and 228 define a plurality of perimeter portions 246 each aligned at an acute angle 242 relative to first direction 206. For example, in the exemplary embodiment, first portion 230 and second portion 232 of insert 200 each define sawtooth-shaped portions 246 of perimeter 228, with each sawtooth portion 246 defining multiple respective acute angles 242 with respect to first direction 206. Insert 200 is again coupled to substrate 202 by a brazed metallurgical bond at least between recess perimeter 226 and insert perimeter 228, and respective acute angles 242 are again selected such that the brazed metallurgical bond is in shear when substrate 202 is subjected to tensile stress 204. For example, each acute angle 242 is less than or equal to about 30 degrees. For another example, each acute angle 242 is less than or equal to about 20 degrees. In alternative embodiments, each acute angle 242 has any suitable value and/or insert 200 has any other suitable shape that enables insert 200 to function as described herein. In operation, tensile stress 204 is again transferred to insert 200 through shear stress 240 along the brazed metallurgical bond. Moreover, because the shear-loaded perimeter 228 of insert 200 is relatively lengthened by the sawtooth shape of portions 246, a load carrying capacity of insert 200 is correspondingly increased.

Although the embodiments illustrated in FIGS. 6 and 7 do not illustrate first width 220 of first portion 214 and second width 222 of second portion 216 each are wider than third width 224 of third portion 218, as described with respect to FIGS. 4 and 5, and instead rely on the plurality of perimeter portions 246 each aligned at an acute angle 242 relative to first direction 206 to improve a load carrying capacity of insert 200, it should be understood that in some embodiments, plurality of perimeter portions each aligned at an acute angle 242 relative to first direction 206 are used in combination with first width 220 of first portion 214 and second width 222 of second portion 216 are each wider than third width 224 of third portion 218 to further increase a load carrying capacity of insert 200. Furthermore, in certain embodiments, first width 220 of first portion 214 is wider than third width 224 of third portion 218, as described with respect to FIGS. 4 and 5, and second width 222 of second portion 216 is smaller than third width 224 of third portion 218 as described with respect to FIGS. 6 and 7.

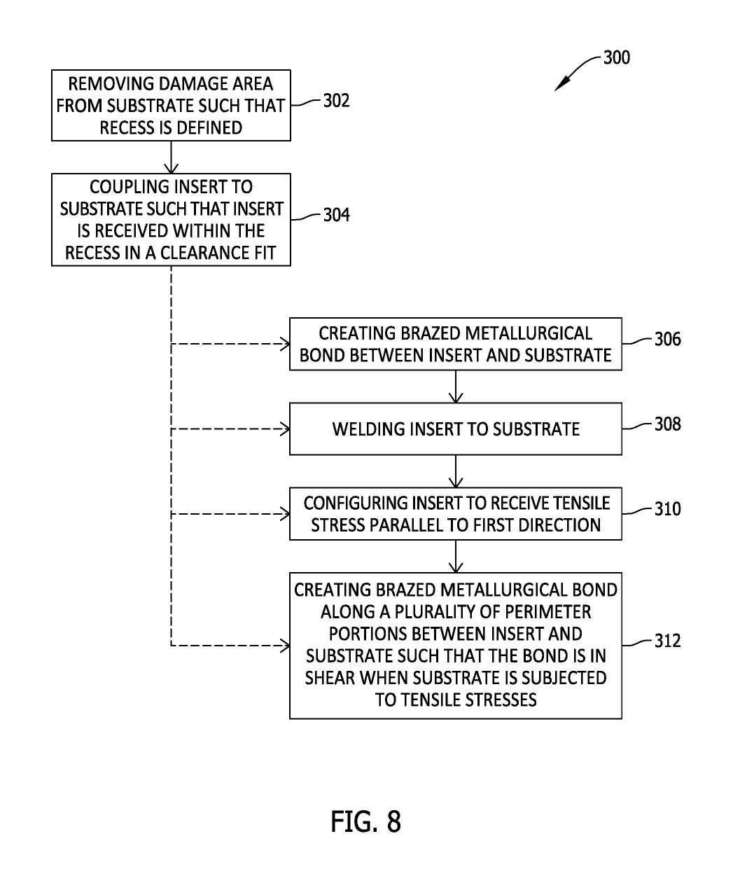

An exemplary method 300 for repairing a component of a rotary machine, such as rotor blade 126 (shown in FIG. 3) of rotary machine 100 (shown in FIG. 1), is illustrated in the flow diagram of FIG. 8. With reference also to FIGS. 1-7, exemplary method 300 includes removing 302 a damaged area from a substrate, such as substrate 202, of the component such that a recess, such as recess 210, is created in a surface of the substrate, such as surface 212. The substrate is receives tensile stress, such as tensile stress 204, in a first direction, such as first direction 206, when the component is in operation on a rotary machine. The recess includes a first portion, such as first portion 214, having a first width, such as first width 220, defined in a second direction, such as second direction 208, extending substantially transverse to the first direction along the surface. The recess also includes a second portion, such as second portion 216, having a second width, such as second width 222, defined substantially parallel to the second direction, and a third portion, such as third portion 218, between the first and second portions relative to the first direction. The third portion has a third width, such as third width 224, defined substantially parallel to the second direction, such that each of the first width and the second width is different than the third width. Method 300 further includes coupling 304 an insert, such as insert 200, to the substrate. A perimeter of the insert, such as perimeter 228, is sized substantially identically to a perimeter of the recess, such as perimeter 226, such that the insert is received within the recess in a clearance fit.

In certain embodiments, method 300 includes creating 306 a brazed metallurgical bond defined between the insert and the substrate. Additionally or alternatively, method 300 includes welding 308 the insert to the substrate. Additionally or alternatively, method 300 further includes configuring 310 the insert to receive tensile stress substantially parallel to the first direction from the substrate when the rotary machine is in operation.

In certain embodiments, the recess perimeter includes a plurality of perimeter portions, such as perimeter portions 246, that are each aligned at an acute angle, such as acute angles 242, relative to the first direction, and method 300 further includes creating 312 a brazed metallurgical bond defined between the insert and the substrate along the plurality of perimeter portions such that the brazed metallurgical bond is in shear when the substrate is subjected to the tensile stress.

Exemplary embodiments of repair inserts and methods for repairing a component of a rotary machine are described above in detail. The embodiments described herein provide several advantages in repairing rotary machine components. Specifically, the repair insert and methods described herein facilitate increasing the strength of the repair and reducing or eliminating a need for structural weld repair. Some embodiments described herein provide advantages in that the repair insert receives tensile stress directly from the substrate, without a need to rely on a bond created between the insert and the substrate. Certain embodiments provide an advantage in that tensile stress in the substrate are transferred to the repair insert substantially through shear in a brazed metallurgical bond, which performs better than a brazed metallurgical bond subjected to tensile stress. The repair inserts and method described herein enable a higher strength of repair to damaged rotary machine components thus increasing service life.

The repair inserts and methods described herein are not limited to the specific embodiments described herein. For example, components of each system and/or steps of each method may be used and/or practiced independently and separately from other components and/or steps described herein. In addition, each component and/or step may also be used and/or practiced with other assemblies and methods.

While the disclosure has been described in terms of various specific embodiments, those skilled in the art will recognize that the disclosure can be practiced with modification within the spirit and scope of the claims. Although specific features of various embodiments of the disclosure may be shown in some drawings and not in others, this is for convenience only. Moreover, references to “one embodiment” in the above description are not intended to be interpreted as excluding the existence of additional embodiments that also incorporate the recited features. In accordance with the principles of the disclosure, and feature of a drawing may be referenced and/or claimed in combination with any feature of any other drawing.

What is claimed is:

1. A component comprising:
a substrate configured to receive tensile stress in a first direction, said substrate comprising a recess defined therein on a surface of said substrate, said recess comprising:
a first portion having a first width defined in a second direction extending substantially transverse to the first direction along said surface;
a second portion having a second width defined substantially parallel to the second direction; and
a third portion between said first and second portions along the first direction, said third portion having a third width defined substantially parallel to the second direction such that each of the first width and the second width is different than the third width; and
an insert coupled to said substrate, wherein a perimeter of said insert is sized substantially identically to a perimeter of said recess such that said insert is received within said recess in a clearance fit.

2. The component in accordance with claim 1, wherein at least one of the first width and the second width is more than the third width.

3. The component in accordance with claim 1, wherein at least one of the first width and the second width is more than twice the third width.

4. The component in accordance with claim 1, wherein at least one of the first width and the second width is less than the third width.

5. The component in accordance with claim 1 further comprising a brazed metallurgical bond defined between said insert and said substrate.

6. The component in accordance with claim 1 further comprising a weld between said insert and said substrate.

7. The component in accordance with claim 1, wherein said insert is configured to receive tensile stress substantially parallel to the first direction from said substrate.

8. The component in accordance with claim 1, wherein said recess perimeter comprises a plurality of perimeter portions that are each aligned at an acute angle relative to the first direction, said component further comprising a brazed metallurgical bond defined between said insert and said substrate along said plurality of perimeter portions such that said brazed metallurgical bond is in shear when said substrate is subjected to tensile stress.

9. A rotary machine comprising:
a component configured to receive tensile stress when said rotary machine is in operation, said component comprising a substrate and a recess defined therein on a surface of said substrate, said recess comprising:
a first portion having a first width defined substantially transverse to tensile stress along said substrate;
a second portion having a second width defined substantially transverse to tensile stress along said substrate; and
a third portion between said first and second portions along the tensile stress direction, said third portion having a third width defined substantially transverse to tensile stress along said substrate such that each of the first width and the second width is different than the third width; and
an insert coupled to said substrate, wherein a perimeter of said insert is sized substantially identically to a perimeter of said recess such that insert is received within said recess in a clearance fit.

10. The rotary machine in accordance with claim 9, wherein at least one of the first width and the second width is more than the third width.

11. The rotary machine in accordance with claim 9, wherein at least one of the first width and the second width is more than twice the third width.

12. The rotary machine in accordance with claim 9, wherein at least one of the first width and the second width is less than the third width.

13. The rotary machine in accordance with claim 9 further comprising a brazed metallurgical bond defined between said insert and said substrate.

14. The rotary machine in accordance with claim 9 further comprising a weld between said insert and said substrate.

15. The component in accordance with claim 9, wherein said recess perimeter comprises a plurality of perimeter portions that are each aligned at an acute angle relative to the first direction, said component further comprising a brazed metallurgical bond defined between said insert and said substrate along said plurality of perimeter portions such that said brazed metallurgical bond is in shear when said substrate is subjected to tensile stress.

16. A method for repairing a component, said method comprising:
removing a damaged area from a substrate of the component such that a recess is created in a surface of the substrate, wherein the substrate is configured to receive tensile stress in a first direction, wherein the recess is formed with:
a first portion having a first width defined in a second direction extending substantially transverse to the first direction along the surface;
a second portion having a second width defined substantially parallel to the second direction; and
a third portion between the first and second portions and having a third width defined substantially parallel to the second direction such that each of the first and second widths are different than the third width; and
coupling an insert to the substrate, wherein a perimeter of the insert is sized substantially identically to a perimeter of the recess such that the insert is received within the recess in a clearance fit.

17. The method according to claim 16 further comprising creating a brazed metallurgical bond defined between the insert and the substrate.

18. The method according to claim 16 further comprising welding the insert to the substrate.

19. The method according to claim 16 further comprising configuring the insert to receive tensile stress substantially parallel to the first direction from the substrate.

20. The method according to claim 16, wherein the recess perimeter includes a plurality of perimeter portions that are each aligned at an acute angle relative to the first direction, said method further comprising creating a brazed metallurgical bond defined between the insert and the substrate along the plurality of perimeter portions such that the brazed metallurgical bond is in shear when the substrate is subjected to the tensile stress.
